(19) United States
(12) Patent Application Publication
(10) Pub. No.: US 2014/0099253 A1
(43) Pub. Date: Apr. 10, 2014

(54) METHOD AND APPARATUS FOR MAGNETIC TREAMENT OF FUEL AND FLUIDS FOR COMBUSTIION EFFICIENCY AND REDUCTION OF CARBON EMISSIONS

(71) Applicant: Peter A. Kulish, Doylestown, PA (US)

(72) Inventor: Peter A. Kulish, Doylestown, PA (US)

(21) Appl. No.: 13/476,066

(22) Filed: Oct. 5, 2012

(51) Int. Cl. F02M 27/04; H01F 7/02

(52) U.S. Cl. CPC F02M 27/045; H01F 7/0294; F02M 27/00
USPC 423/649; 335/306; 210/222

(57) ABSTRACT

Magnetic treatment devices used in a system to enhance fuel combustion for the reduction of carbon emissions and to increase fuel efficiency. A series of uniquely constructed ferrous back plates with accompanying permanent homopolar magnetic assemblies are utilized to produce the aforementioned effect. The homopolar assemblies are field specific to the combustion fluid.

### CROSS REFERENCE TO RELATED APPLICATIONS

None

### FEDERALLY SPONSORED RESEARCH OR DEVELOPMENT

None

### SEQUENCE LISTING

None

### BACKGROUND

### Prior Art

U.S. Patents

| Patent Number | Kind Code | Issue Date | Patentee |
|---|---|---|---|
| 3,228,868 | B1 | Jan. 11, 1966 | Ruskin |
| 4,188,296 | B1 | Feb. 12, 1980 | Fujita |
| 4,424,786 | B1 | Jan. 10, 1984 | Imbert |
| 5,129,382 | B1 | Jul. 14, 1992 | Stamps |
| 5,145,585 | B1 | Sep. 08, 1992 | Coke |
| 5,348,050 | B1 | Sep. 20, 1994 | Ashton |
| 5,829,420 | B1 | Nov. 02, 1998 | Kita-Kulish |
| 6,890,432 | B1 | May 10, 2005 | Witz |

### BACKGROUND OF INVENTION

The effects of a magnetic field upon a flame was initially investigated by Michael Faraday in his book entitled: Experimental Researches in Electricity that was published in 1846. On page 467 of Faraday research notes a section entitled: On the Diamagnetic Condition of Flame Gases is presented.

In the opening section he notes that the nature of a flame is diamagnetic and that the flame is repelled from its axial line when it is positioned between two magnets. In this instance Faraday was merely duplicating research that was conducted by Professor Zantedeschi as related in Philosophical Magazine, the major purveyor of scientific thought at the time. Faraday had an intrinsic interest in this field and much of the research conducted in this field used electro-magnets as developed in Italy; consequently Zantedeschi became one of the leading researchers in this field. During this era, static magnets were not of sufficient strength to be influential on a flame. Notes on this research are found in Philosophical Magazine Section 3 Vol. XXXI No. 210 December 1847.

The effect of a magnetic field on a flame was to compress the flame between the points of the electromagnet. On raising the flame a little more, the effect of the magnetic force was to increase the intensity of the results just described, and the flame actually became a fish-tail shape, disposed across the magnetic axis and when the field was removed, the flame resumed its normal upright position. Also cited: A ball of cotton, bound up about the size of a peanut, soaked in ether and ignited, will give a flame six or seven inches high. This large flame rides freely and naturally between the non-active poles, but as soon as the electromagnet is rendered active, it divides and passes off in two flames, one on one side and one on the other side of the axial line. This important and exciting action, we owe to the work of Italian researcher Professor Bancalari. Professor Zantedeschi also related that different flames such as those produced by camphor, hydrogen, sulfur, phosphorous, all were affected in a similar manner, though not apparently with equal strength and that the brightest flames appeared to be most affected. Faraday also notes that the composition of smoke was also altered by subjecting a smoking taper to a magnetic field. Though the effect is manifest in a flame, it is not, at first sight, evident what is the chief cause of the result. The heat of the flame is the most apparent and probable condition, but there are other circumstances that may be equally influential.

Solid particulate matter, which is known to be diamagnetic, existed in several of the flames used, but Faraday was concerned with the paramagnetic properties of air and its interaction with a magnetic field through the operation of an electromagnet. Of special note, Faraday also recorded temperature changes with a very delicate thermometer with respect to this effect. These are in Faraday's notes numbered 2423, 2424, 2367 and 2438, 2350, 2397.

Faraday also investigated the components of air-oxygen and nitrogen with respect to a magnetic field. In his experiments that involve the delivery of gases through jets, he noted that nitrogen was diamagnetic relative to oxygen. Faraday's investigation into hydrogen proved it to be highly diamagnetic relative to other substances. Also it was Faraday's belief that a flame undergoing the action of a series magnetic fields should undergo a change in spectral emission, however, due to the limited strength of magnets at this time, it was never witnessed.

Another basic study is the magnetic influence with respect to combustion was conducted by Simon Ruskin U.S. Pat. No. 3,228,868. Ruskin studied the effects of a magnetic field on hydrogen with respect to hydrogen stored for use in missile fuel. Hydrogen based fuel as used in rockets is stored in its natural para-hydrogen state, since it was discovered that the para-hydrogen state is more stable and less reactive. Dr. Ruskin discovered that when a static magnetic field is applied to para-hydrogen, it converts to the more reactive ortho-hydrogen state resulting in a greater release of energy.

Reviewing the vector of the parallel and orthogonal spin relationship of the non-energized and energized hydrogen, the para-hydrogen state is the spin state in which one hydrogen spin vector is up and the other spin vector is down. In the ortho-hydrogen spin vector state both spin vectors are in the up position, thus rendering the molecule more reactive.

The Imbert U.S. Pat. No. 4,424,786 relates the combustion of fuel enhancement through the use of an electro-magnetic coil attached to the air intake duct of an automotive vehicle. Periodically a switch is manually thrown to change the polarity of the electro-magnet, this maintains the efficiency of the effect.

In the Kita Kulish U.S. Pat. No. 5,829,420 stoichiometric combustion is achieved through the use of an electromagnet that is heuristically controlled by a microprocessor that monitors the by-product gases of combustion and accordingly modifies the magnetic field on the air induction as well as fuel induction systems of an automotive engine.

It was the Fujito U.S. Pat. No. 4,188,296 that indicated the non-linear quantum mechanical nature of a magnetic field impinging upon a hydrocarbon fuel. The nature of the fuel used in the Fujito Patent was comprised of a light heating oil. Such fuels are high in benzene content and are diamagnetic in nature. Benzene and its accompanying benzene electron currents give rise to its diamagnetic properties.

While in past, researchers have attributed the magnetic forces for the de-clustering of molecular associations and thus reducing the kinematic viscosity of the fluid. Such viscosity reduction did occur in high viscosity oils such as crude oil but not occur in the realm of lower viscosities fuels.

If magnet viscosity effects were to occur, the effect would represent a linear condition. More magnetic field intensity would give rise to increased de-clustering of the molecules. However, if one examines the series of fuel, magnetic combustion curves of Fujito, one will note that there are specific windows of optimal magnetic field intensity.

It appears the fuels will accept specific magnetic energies. The effect is of a non-linear nature is suggestive that a quantum energy transfer is occurring. Clustering of molecules are determined by their physio-chemical nature as well as Van der Waal forces. It should be remembered that Van der Waal forces are inverse third power force, and in many cases the forces are not significant in relation to other operable treatments. Also, fuels such as oil of high benzene content are non-polar. This is due to the symmetry of the benzene ring C⁶H⁶, having equal distribution of electrons. However, being a fluid, the normal non-polar benzene electrons can be excited by the inducement of a magnetic field which because unlike a solid, its fluid nature can be re-configured into a dipolar state when taking on the same electromotive magnetic polar energy thereby repelling itself from other associative benzene clustered molecules, thus resulting in greater oxidation and energy release.

In the 1800 quantum mechanics didn't exist, but Faraday as aforementioned, speculated that a magnetic field may alter the spectral properties of a flame; however, magnets of his day were incapable of providing such an observation.

Through the use of spectral monitoring equipment such as the Purple Peeper® registered trademark of the Honeywell Corporation, the presence of the ultraviolet flame in the combustion of natural gas is measured during the ongoing ignition of the gas which will show any changes of the combustion/flame from the continuing fuel entering the combustion chamber such as in a boiler. It was discovered that when a permanent magnet assembly is attached to gas conduit downstream of the point of ignition for a boiler, the monitoring Purple Peeper device detected a change in the ultraviolet specter. Depending upon the magnetic field design, ultraviolet availability of the flame index readings have been known to increase from a maximum of 1.8 to 2.0 after installation. This observation confirms what Faraday speculated would occur in his lab notes of the 1800s in regard to the spectral intensity change.

Over the years scientists have speculated about the existence of a magnetic monopole because such monopole would represent a discrete unit of magnetism and its driving force that excites the electron, just as an electron represents a discrete unit charge of electricity.

In the Physical Review 01:733(1942) in a paper entitled “Further facts concerning the magnetic current” the observed nature of the monopole is related.

Dr. Felix Ehrenhaft was a professor of physics at the University of Vienna. The concept of a discrete unit of magnetic charge may represent the quantum mechanical effects that are demonstrated in the combustion graphs in Fujito's magnetic fuel combustion patent U.S. Pat. No. 4,188,296.

Jet Propulsion Laboratory combustion experiments show untreated para-hydrogen fuel drop's middle molecules only burn partially or not at all resulting in emissions output of soot, smoke, hydrocarbon particulate, NOX; most of which are basically unburned or partially burned “middles.”

When the fuel is converted by a magnetic field of suitable strength into ortho-hydrogen fuel, the electrons that the fuel molecules are mutually repelled thereby breaking through the surface tension of each drop within nanoseconds of entering the combustion chamber and splitting into thousands and millions of microdrops with many fewer middle drops and much more molecular surface area available for oxygen ionization resulting in a greater oxidation and thereby less unburned emissions and a greater BTU release every ignition stroke.

The U.S DOE Federal Technology Alert (FTA) reports that magnetic water conditioning of process equipment such as boilers increases thermal transfer efficiency thereby working directly in conjunction with combustion efficiency. The following FTA abstract covers this subject matter:
The magnetic technology has been cited in the literature and investigated since the turn of the 19^{th} century, when lodestones and naturally occurring magnetic mineral formations were used to decrease the formation of scale in cooking and laundry applications. Today, advances in magnetic and electrostatic scale control technologies have led to their becoming reliable energy savers in certain applications.
For example, magnetic or electrostatic scale control technologies can be used as a replacement for most water-softening equipment. Specifically, chemical softening (lime or lime-soda softening), ion exchange, and reverse osmosis, when used for the control of hardness, could potentially be replaced by non-chemical water conditioning technology. This would include applications both to cooling water treatment and boiler water treatment in once-through and re-circulating systems.
The primary energy savings from this technology result from decrease in energy consumption in heating or cooling applications. This savings is associated with the prevention or removal of scale build-up on a heat exchange surface, where even a thin film can increase energy consumption by nearly 10%. Secondary energy savings can be attributed to reducing the pump load, or system pressure, required to move the water through a scale-free, unrestricted piping system.

### DISCUSSION OF PRIOR ART

An internet search of http://www.google.com/patents using the descriptions: “magnet fuel treatment” and “back plate” reveals the following relevant prior art: Ashton U.S. Pat. No. 5,348,050, Witz U.S. Pat. No. 6,890,432 and Stamp U.S. Pat. No. 5,129,382. In the patent by Ashton U.S. Pat. No. 5,348,050, a discussion in which the use of ferrous backing plates to increase the effective gauss rating of the magnet is discussed. Also discussed is an addition gap backing plate to create a magnetic loop thus connecting the two halves of the magnetic device. The back plate in this instance is merely functioning as a bridge. In addition, placing a series of magnets inside a tube-like steel shell is discussed. It should be noted that in the patent of Ashton that the ferrous back plate is tangent to the surface and does not encompass the sides of the magnet.

In U.S. Pat. No. 5,129,382, a combustion efficiency device by Stamp, a magnetic back plate may be provided on the positive or geological south pole to produce a stronger flux field on the negative geological north pole of the magnet. It is also cited that a metallic back plate is preferably non-magnetic steel.

In U.S. Pat. No. 6,890,432 entitled: Magnetic Fuel Treatment Apparatus for Attachment to a Fuel Line by Witz, a magnet cover plate is discussed as a constructed preferably from a relatively non-magnetic material such as chrome-plated brass. From the description as given in the patent the cover plate appears to be more of a decorative nature than of a functional nature.

In U.S. Pat. No. 5,145,585 entitled Method and apparatus for treating water in a cooling system by Coke, the water from a cooling tower is subjected to a magnetic field to dissolve the scale and corrosion.

### SUMMARY AND OBJECT OF INVENTION

It is an object of this invention to provide a means providing stoichiometric combustion of a hydrogen-based fuel through the use of permanent magnetic fields with accompanying ferrous plates in order to achieve appropriate levels of flux intensity into the fluid conduits thereby eliminating the need for electromagnetic treatment devices, the microprocessor control system, their related sensors to control the magnetically enhanced combustion process, their engineering, and their software testing cycle requirements thereby not incurring all the costs that such equipment implementation requires. Also it is the object of the invention to provide a stable magnetic field intensity into the fluids of between 800 gauss and 2000 gauss.

Yet another object of the invention is to provide a stable positive magnetic field into the fuel in accordance with the gauss ranges as cited above through the use of a specially formed soft ferrous material opposition flux driver backplate and flux circuit plate which acts as a flux circuit that enables the required Gaussian density to go through any ferrous or non-ferrous conduit to be imparted into the fuel to achieve micro-drops by electromotively breaking the bonds of the normal larger fuel drops or gaseous molecular associations. The operability of the opposition flux driver backplate is dependent on the proximity of the plural like pole pieces attached to the backplate so that the flux field of each equal pole is repelled from each other through the soft ferrous steel backplate which mutually drives the flux toward the opposite pole pieces toward and through the axis of any ferrous or non-ferrous conduit and accordingly into the flowing fuel. The operability of the flux circuit plate above the conduit and pole pieces is to create a focused path of magnetic energy to work in conjunction with the opposition flux driver backplate in pulling and maintaining the flux field density from the pole pieces through the conduit into the fuel and into the flux circuit plate to circuit back to the opposition flux driver back plate. The flux circuit plate is used with the opposition flux driver backplate to maintain the Positive energy value required for the proper fuel treatment.

Also another object of the invention is to provide a magnetic field or series of negative geological north treatment magnetic fields through the use of a specially formed soft ferrous material opposition flux driver backplate that drives the flux through any ferrous or non-ferrous air conduit to treat and encompass the air to enhance the energy component of the Negatively charged oxygen whose electromotive potential attraction is increased to the positively charged fuel resulting in increased ionization of the fuel molecules.

Also another object of the invention is to provide a magnetic field or series of positive magnetic fields through the use of a specially formed soft ferrous material opposition flux driver backplate to encompass the positive treatment of the cooling fluid as an additional component to the fuel and air magnetic treatments by energizing the cylinder walls or water or steam boiler for increased ionization and/or increased combustion efficiency through increased thermal transfer efficiency.

### BRIEF DESCRIPTION OF THE DRAWINGS

FIG. 1 represents a side view of a magnet depicting the de-magnetization field. FIG. 2a represents an isometric view of the flux driver backplate magnetic device.

FIG. 2b represents an isometric view of flux circuit plate and the flux driver backplate magnetic device assembly.

FIG. 3 represents a frontal view of the magnetic assembly on the conduit.

FIG. 4 represents an isometric view of a polyhedral flux driver backplate

### DESCRIPTION OF THE PREFERRED EMBODIMENT

In the magnet industry there is a term that is widely used: magnetic assembly. The term not only relates to a permanent magnet configuration, but relates a permanent magnet in relation to a ferrous housing or plates or the like. In many situations where the focusing or modifying of the magnetic field is required the magnetic assembly, the ferrous structure, is as important as the magnet itself.

Also it should be noted that ferrous magnetic back plates are not to be considered as magnetic keepers. The use of magnetic keepers represent technology that reflects a time in which ferrous magnets were made of a soft material and a ferrous plate was used to entrain the flux between the negative and positive pole thus keeping or maintaining the life of the magnet. A magnet back plate of this new design performs an entirely different role. The function of the back plate is increase the field intensity of the magnet and to redirect the flux pattern itself

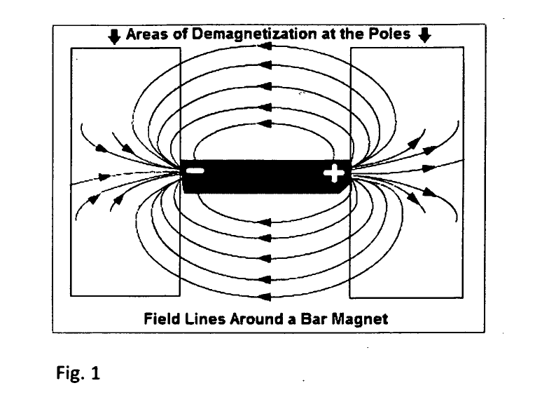

Heretofore most back plates such as the art related in Ashton's U.S. Pat. No. 5,348,050 depicts a planar ferrous plate that is mounted tangentially to one side of the magnet. With respect to magnetic treatment of fuel and the like, rectangular magnets are commonly utilized. At each pole of a permanent magnet there exists a demagnetization field. This does not represent a true demagnetization of the permanent magnet, but rather represents the redirection of the magnetic field. This redirection is what allows the flux lines to reconnect to the poles of the permanent magnet. FIG. 1 represents the demagnetization field as it is emitted from the pole of a rectangular magnet. These lines of force and adjacent magnetic flux lines omitting from the pole piece and flowing around the magnet towards its opposite pole again represents the demagnetization field.

However, when a suitably design ferrous back plate is utilized, the demagnetization field is altered and can be redirected to increase its energy value.

The term demagnetization field is actually a mutual repulsion of the flux lines as it leaves the poles of a permanent magnet or magnetic solenoid. The properties of the demagnetization field are determined by two major factors: field intensity of the magnet at the exiting pole and the length of the magnet. It is mutual repulsion of the flux lines at the pole of the magnet that initiates the start of a magnetic loop that allows the magnetic field to terminate at the opposite end of the magnet.

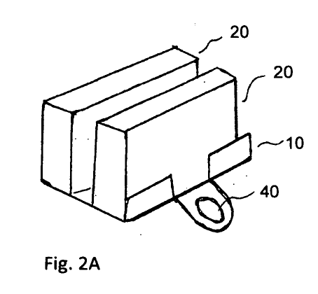

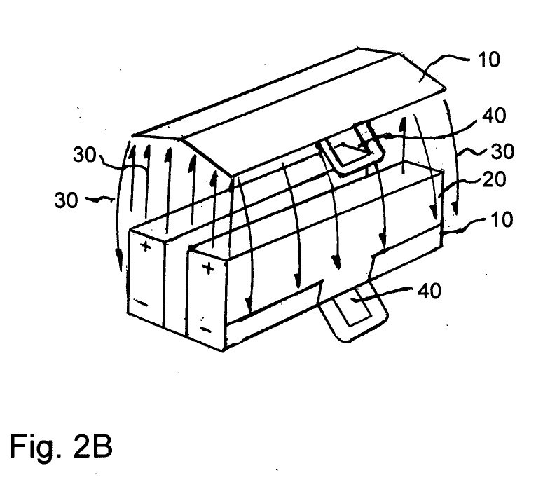

A suitably constructed back plate will produce a higher gauss level at the opposite end of the magnet on which the back plate is located. Accordingly, in order to create a higher flux density on the opposite end of the magnet, a backplate comprising of a soft ferrous material and plural permanent magnets is constructed in accordance with FIG. 2a. It should be noted that the backplate purpose is to secure magnets 20 to plate 10 as well as serving as an agent for modifying field 30.

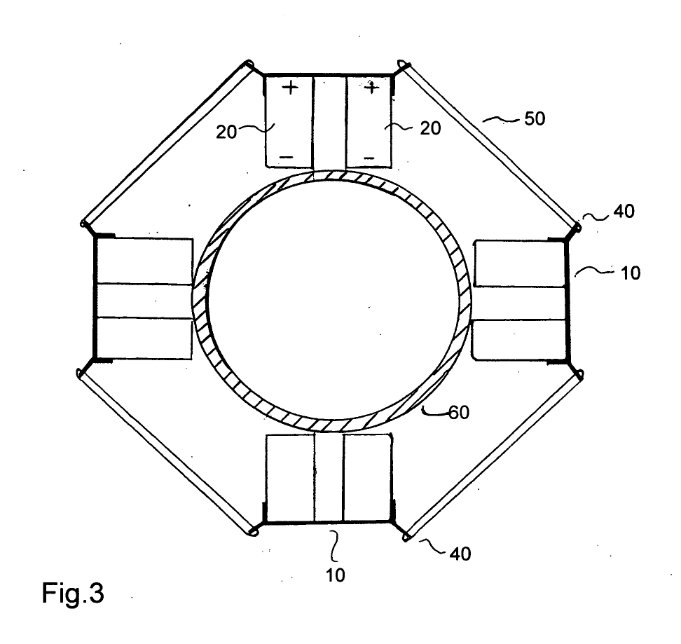

To affect the change in magnetic field 30, a series of tabs are bent at angles ranging from 80 to 100 arcuate degrees. The tab is formed by the bending of the backplate 10 that alters the demagnetization field in such a way as to increase the power of the positive pole that exists from magnetic pole that is located in opposition to negative pole that is secured by plate 10 and vice versa. Also, it is to be noted that a singular or plurality of magnets may be utilized. In FIG. 2a, two magnets 20 possessing same pole orientations are rigidly attached to plate 10. A gap is provided between both same pole magnets. Since the flux produced by the same pole magnets produce an opposing series of fields when the magnetic flux enters the backplate, this accordingly provides an increase in the flux density as experienced by the poles located on the opposite face of the magnet. A securing backplate 30 comprised of ferrous material is of magnetic permeability due to the soft nature of the grain structure of the material. Such a plate is provided with holes 40 located in such plate as to align with backplate 10. According a fastener 50 can be inserted through the aligned holes and tightened about the periphery of fuel conduit 60. Fasteners utilization for such purpose may consist of bolt assemblies, straps, screws, rivets or the like. The securing backplate 10 is constituted of a ferrous material serves to strengthen the flux produced at the pole pieces of the permanent magnets 20. The securing backplate 10 may be planar with respect to backplate 10 or it may be bent with respect to backplate 10 at a dihydral angle theta as shown in FIG. 2b. This plate acting in conjunction with the magnetic assembly pulls the magnetic energy from the pole pieces through the ferrous or non-ferrous conduit with the fluid or fuel contained therein thus experiencing a much higher flux density needed to arrive at stochiometric combustion; this increase in magnetic flux density occurs by the plate completing the magnetic circuit. In FIG. 3 the securing backplate 10 is depicted with the aforementioned formed plate. The purpose of the series of backplates is to produce a gauss intensity on a fluid or fuel flowing through conduct 60 that is within the range of optimal treatment. It has been proven through experimentation and commercialization of such devices that the effect of a magnetic field to produce stoichiometric combustion is non-linear and that according, a specific field intensity must be maintained as to provide consistent performance of such devices.

Also, FIG. 3 can be utilized as a device for treating the air induction of any combustion device if the polarity of the magnetic field is negative with the respect to the oxygen flowing in the conduit.

While it is preferable to use a ferrous, paramagnetic material in the construction of a backplate, it should be noted that any material that is capable of modifying a magnetic field can be used. Diamagnetic material can modify the action of a magnetic field and consequently are also candidates for such application, and an example is bismuth which has the greatest diamagnetic property of the common elements. In terms of other paramagnetic material, iron, steel, and other common ferrous materials are known and widely used. However, special materials such as metallic glass materials are of use. A metallic glass material is a material of ferrous origins—in which the solidification of the material is faster than the crystallization of the material, hence the material that forms is in a amorphous non-crystalline or glassy state.

With respect permanent magnetic material that falls within the scope of this invention should include and not be limited to the following magnetic materials: ferrites, alnico neodymium-iron-boron alloy and diamagnetic material magnets such as bismanol. Bismanol magnets were produced during World War II as a means of activating magnetic naval mines. These relatively powerful magnets never saw use in the commercial world. The alloy comprises 50 percent bismuth and 50 percent manganese. Of note, fuel by its molecular nature is diamagnetic, and while ferrite-based magnets, which are iron oxide derived and paramagnetic in nature, bismuth-based magnets, such as Bismanol, made from a diamagnetic element may also be affordably utilized.

In the aforementioned embodiment a magnetic field or series of mutual repelling magnetic fields in conjunction with a backplate are utilized to treat fuel. However, the treatment of oxygen that is a component of air, and is of paramagnetic susceptibility likewise may be treated. While in the preferred embodiment of the fuel treatment the positive pole of the magnet is employed, in the magnetic treatment of the oxygen component of air, the negative pole of a permanent magnet is utilized. Since the molecular density of air is lower than the molecular density of a hydrocarbon fuel, a higher gauss density must be utilized and is required. Such required gauss values in the treatment of air, fuel and coolant must have a minimal range from 800 gauss to 2000 gauss in the actual aforementioned fluids.

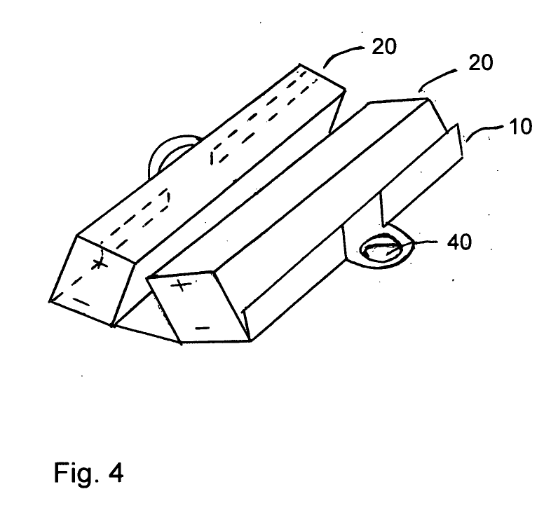

While in the magnetic treatment of fuel a circuit backplate is utilized and required, whereas in the magnetic treatment of air and coolant, this is not desirable. The magnet assembly without the circuit backplate provides the magnetic energy to pass through any ferrous conduit into the fluid without attenuating the magnetic field to less than its optimal state for treatment of the fluid allows the mutually repelling fields to penetrate into the air induction system of the combustion system. It should also be noted that while the mounting of such systems are intended for reciprocating engines, other fuel combustion devices such as: boilers, furnaces and the like can similarly be treated. While a singular pole of a magnetic field can be utilized to stimulate fuel or oxygen molecules, a series of like magnetic poles are placed around the periphery of the air induction system. This is depicted in FIG. 3. In lieu of a securing plate, a series of fasteners are utilized to secure that radial arrangement of magnets to the periphery of the air induction system. FIG. 4 represents the polyhedrally configured flux driver back plate with either positive or negative plural homopolar fields facing the conduit and its fluid to be treated.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention.

What is claimed is:

1. A method and apparatus for the magnetic treatment of fuel and fluids for combustion efficiency and reduction of carbon emissions in which magnetic fields are intensified and concentrated in which the treatment of fuel or fluid in a ferrous or non-ferrous conduit is unrestricted and enhanced, the magnetic treatment device comprising:
a series of magnetic assemblies utilizing a permeable ferrous backplate;
a plurality of same pole magnets, attached by magnetic attraction to said permeable ferrous backplate in which the magnetic fields of each pole oppose each other through the said backplate which employ side tabs or fixtures on the outside edge of each opposing magnet pole piece to maintain the magnets to continue to be attached and not fly off the backplate due to their opposition forces;
a proximate gap between the same magnetic poles on the said backplate which creates an opposing magnetic force in the backplate that drives the flux of each magnet pole from its magnetic attachment at the backplate in the opposite direction generating an extended increased flux density at the opposite pole pieces which fully permeates and axially treats the flowing fluid in a ferrous or non-ferrous conduit without a diminished flux density below the required treatment values and that the said backplate shall be known as an “opposition field flux driver backplate.”

2. A permeable ferrous magnetic receiving flux circuit plate working with the said opposition field flux driver plate as claimed in claim 1, that enhances the fluid treatment with additional flux density energy values by creating a magnetic circuit between the opposition field flux driver backplate and flux circuit plate that pulls and extends the magnetic flux density from the axial treatment pole pieces up through the conduit and its fluid into the center of the receiving circuit plate where the magnetic energy flows to the outer edge of the flux circuit plate to travel back to the opposition field flux driver backplate creating a magnetic circuit that enhances and maintains the required magnetic fluid treatment energy values.

3. A series of magnetic treatment devices as claimed in claims 1 and 2 that are required to treat the fuel and air fluids at the same time as a system enhancing combustion and maintaining stoichiometric values comprising:
a positive magnetic field or fields to treat the fuel before entering the combustion chamber using a single or plural magnetic assemblies of the said opposition flux driver back plate with an optional said flux circuit plate as applicable in the type and size of the combustion process;
a negative magnetic field or fields to treat the air and therefore the oxygen before entering the combustion chamber using a single or plural magnetic assemblies of the said opposition flux driver back plate with an optional said flux circuit plate as applicable in the type and size of the combustion process;
a positive magnetic field or fields using a single or plural magnetic assemblies of the said opposition field flux driver backplate and where applicable to use the said flux circuit plate treat as optional for enhancing the coolant or water for energizing cylinders or furnace combustion wall surfaces with positive energy for prohibiting the lower potential of the non-treated combustion wall surface from naturally absorbing and attenuating the higher energized electromotive potential of the positive and negative energy imparted into the gaseous fluid mixture of the said positive fuel and negative air pre-combustion magnetic fluid treatment which reduces the gaseous electromotive energy resulting in reduced ionization and lower combustion efficiency; and that the positive treatment of the said coolant or water energizes the surface of the combustion chamber or furnace wall raising its electromotive potential which reduces the potential between the wall and the gaseous mixture and thereby reduces the attenuation of electromotive energy of the gaseous mixture resulting greater ionization and combustion efficiency;
a positive magnetic field or fields using a single or plural magnetic assemblies of the said opposition field flux driver backplate as claimed in claim 1, and a flux circuit plate as claimed in claim 2 as optional and where applicable for treating and enhancing the coolant or water in all process equipment to prohibit lower thermal transfer inefficiency by removing scale buildup and corrosion; and that increasing thermal transfer efficiency with the positive coolant or water treatment reduces applicable fuel usage, scale and corrosion maintenance costs, and electrical energy needs which subsequently reduce power stations needs thereby reducing power station emissions where applicable.
